(19) United States
(12) Patent Application Publication
(10) Pub. No.: US 2016/0065488 A1
(43) Pub. Date: Mar. 3, 2016

(54) ELECTRONIC DEVICE FOR ADJUSTING COMPUTING RESOURCES AND METHOD THEREOF

(71) Applicant: Chiun Mai Communication Systems, Inc., New Taipei (TW)

(72) Inventor: SHIH-LUN LIN, New Taipei (TW)

(21) Appl. No.: 14/552,111

(22) Filed: Nov. 24, 2014

(30) Foreign Application Priority Data
Sep. 1, 2014 (CN) 201410440241.8

(51) Int. Cl. H04L 12/923; G06F 17/30; H04L 29/08

(52) U.S. Cl. CPC H04L 47/762; H04L 67/02; G06F 17/30994

(57) ABSTRACT

A method for adjusting computing resources when browsing a webpage includes opening a webpage for browsing, obtaining a source code of the webpage, analyzing contents of the source code, setting anchor points of the webpage according to the analyzed contents of the source code to divide the webpage into a number of layers, estimating an amount of computing resources required for browsing each layer of the webpage, determining browsing operations of a user on the webpage, and providing the computing resources for browsing the layers according to the determined browsing operations, the established anchor points, and the estimated amount of computing resources of each layer. An electronic device for adjusting computing resources when browsing a webpage is also provided.

### FIELD

The present disclosure relates to adjusting computing resources, and more particularly to an electronic device and method thereof for adjusting computing resources while browsing a webpage.

### BACKGROUND

For browsing a webpage, some electronic devices may provide computing resources for browsing the webpage in response to browsing operations on the webpage. Other electronic devices may first determine an amount of computing resources required for browsing an entire webpage, and then provide the computing resources all at once to browse the webpage.

### BRIEF DESCRIPTION OF THE DRAWINGS

Implementations of the present technology will now be described, by way of example only, with reference to the attached figures.

FIG. 1 is a block diagram of an exemplary embodiment of an electronic device.

FIG. 2 is a block diagram of an exemplary embodiment of function modules of the electronic device.

FIG. 3 is a diagrammatic view of an exemplary embodiment of acquiring a source code of a webpage.

FIG. 4 is a diagrammatic view of an exemplary embodiment of setting anchor points of the webpage.

FIG. 5 is a diagrammatic view of an exemplary embodiment of browsing a second layer and a third layer of the webpage.

FIG. 6 is a diagrammatic view of an exemplary embodiment of browsing a first layer and a second layer of the webpage.

FIG. 7 is a diagrammatic view of an exemplary embodiment of browsing a first layer of the webpage.

FIG. 8 is a flowchart diagram of an exemplary embodiment of a method for adjusting computing resources for browsing a webpage.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

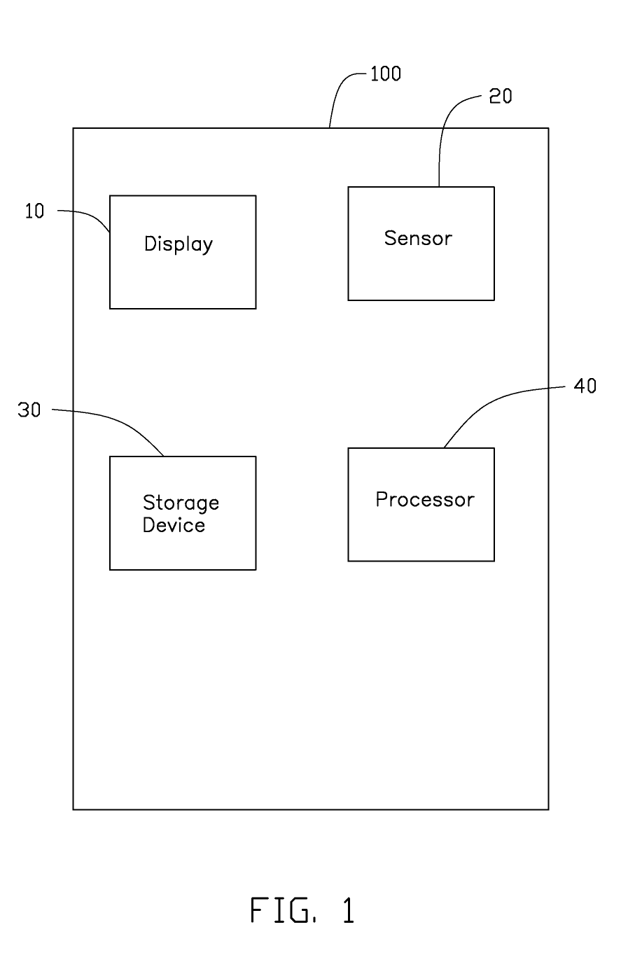

FIG. 1 illustrates an exemplary embodiment of an electronic device 100 for adjusting computing resources when browsing a webpage. The electronic device 100 can include a display 10, a sensor 20, a storage device 30, and a processor 40. The display 10 can receive touch signals from a user and display the webpage. The sensor 20 can detect the touch signals on the display 10. The electronic device 100 can provide an optimal amount of computing resources for browsing the webpage, such that the webpage can be browsed smoothly, and computing resources are not wasted.

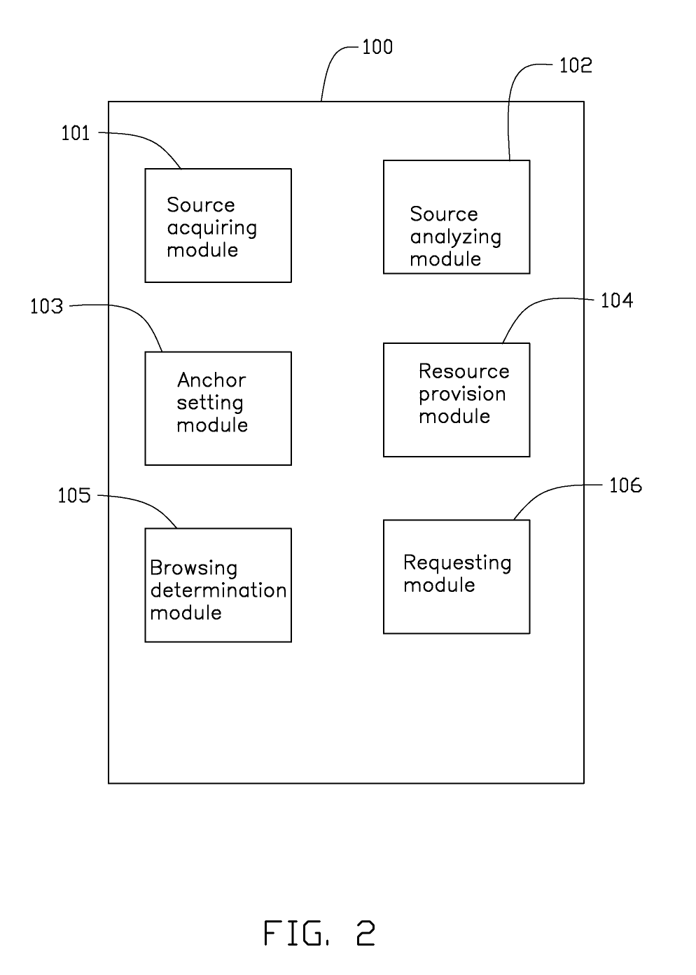

FIG. 2 illustrates an exemplary embodiment of function modules of the electronic device 100. The function modules can include a source acquiring module 101, a source analyzing module 102, an anchor setting module 103, a resource provision module 104, a browsing determination module 105, and a requesting module 106. The modules 101-106 can include one or more software programs in the form of computerized codes stored in the storage device. The computerized codes can include instructions executed by the processor to provide functions for the modules 101-106.

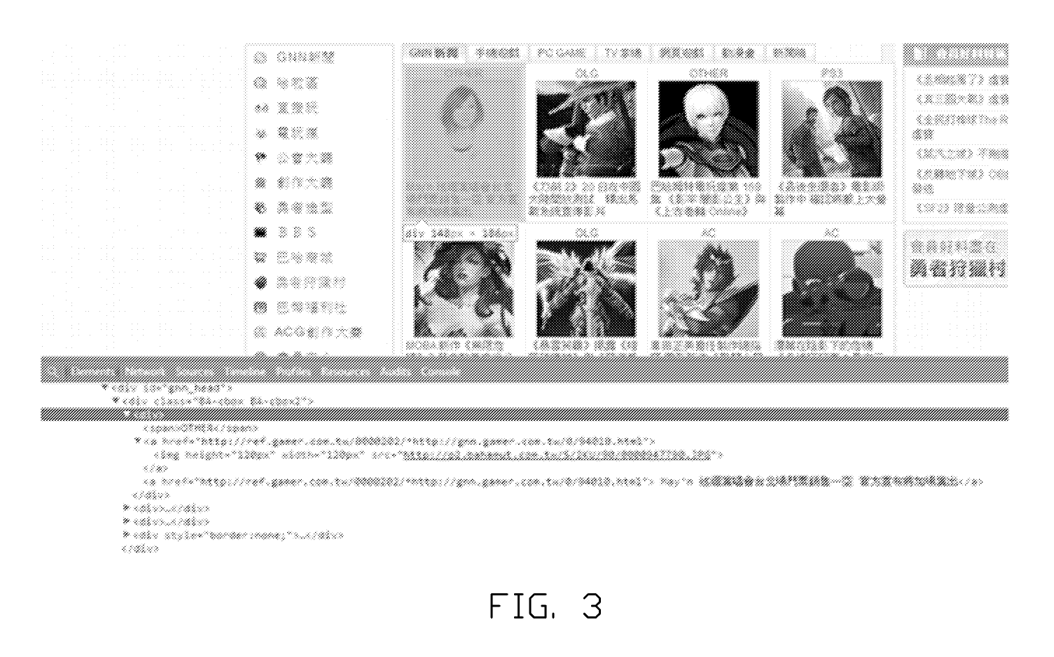

Referring to FIG. 3, the source acquiring module can obtain a source code of the webpage to be browsed. The source analyzing module can analyze the source code to determine a density and distribution of media content of the webpage. The media content can include images, videos, animations, and sounds of the webpage, for example.

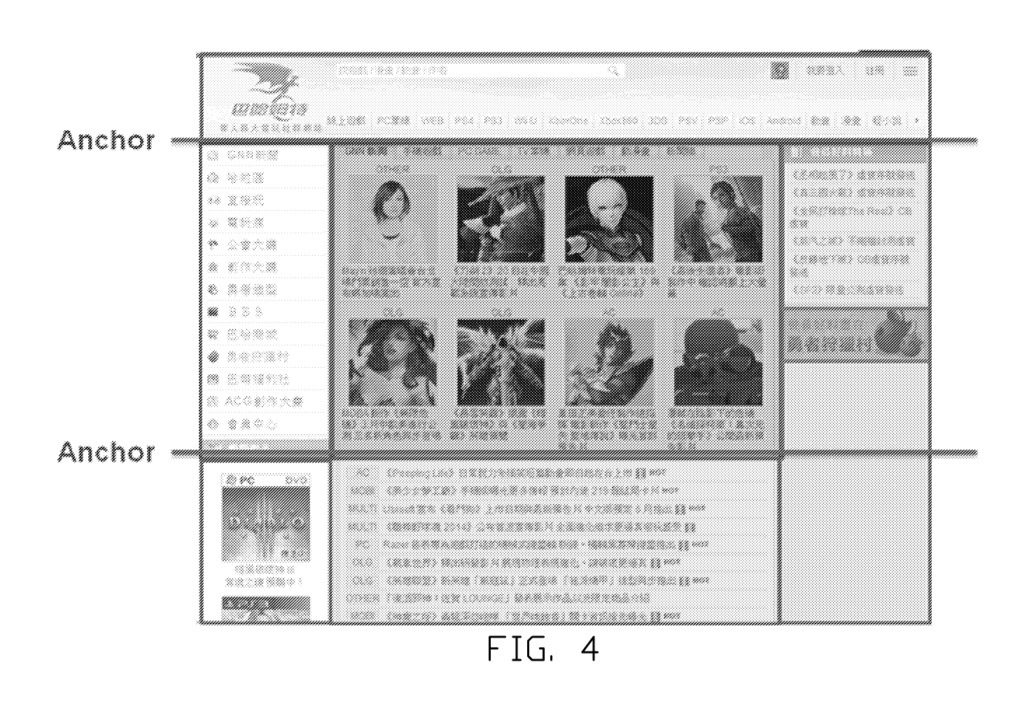

Referring to FIG. 4, the anchor setting module can set anchor points of the webpage to divide the webpage into a plurality of layers according to the density and distribution of the media content. Each layer can be displayed on the display to be browsed, and each layer can have a specified density range of media content. For example, a higher layer can be a layer having a higher density range of media content, and a lower layer can be a layer having a lower density range of media content.

The resource provision module can estimate a required amount of computing resources for browsing each of the plurality of layers, and provide the estimated amount of computing resources when the layers are browsed. In at least one embodiment, the resource provision module provides the estimated amount of computing resources for the layers only when the layers are displayed on the display. Thus, the layers that are not displayed on the screen are not browsed, and power of the electronic device can be saved.

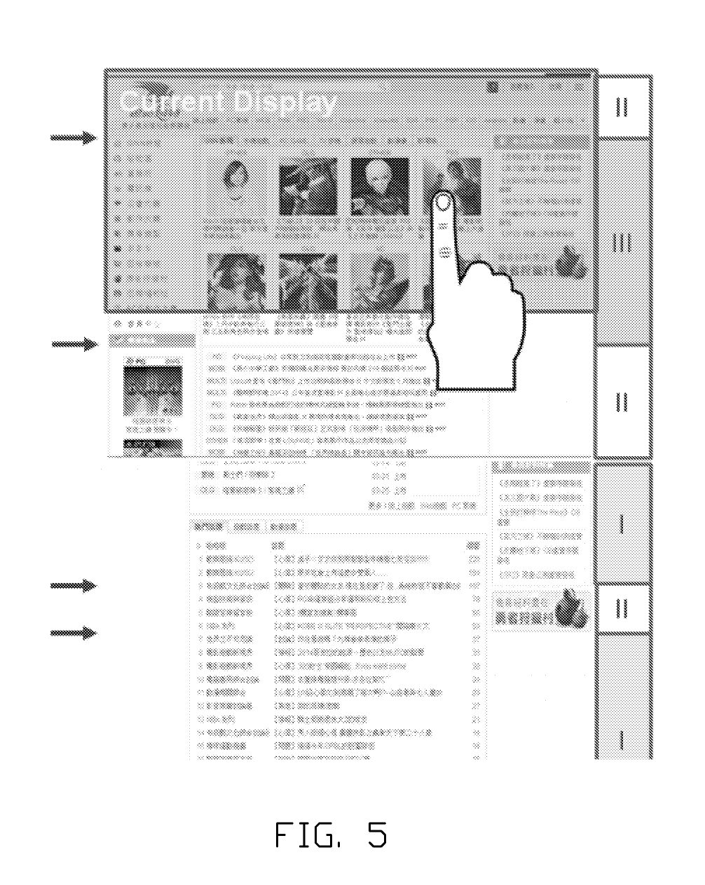

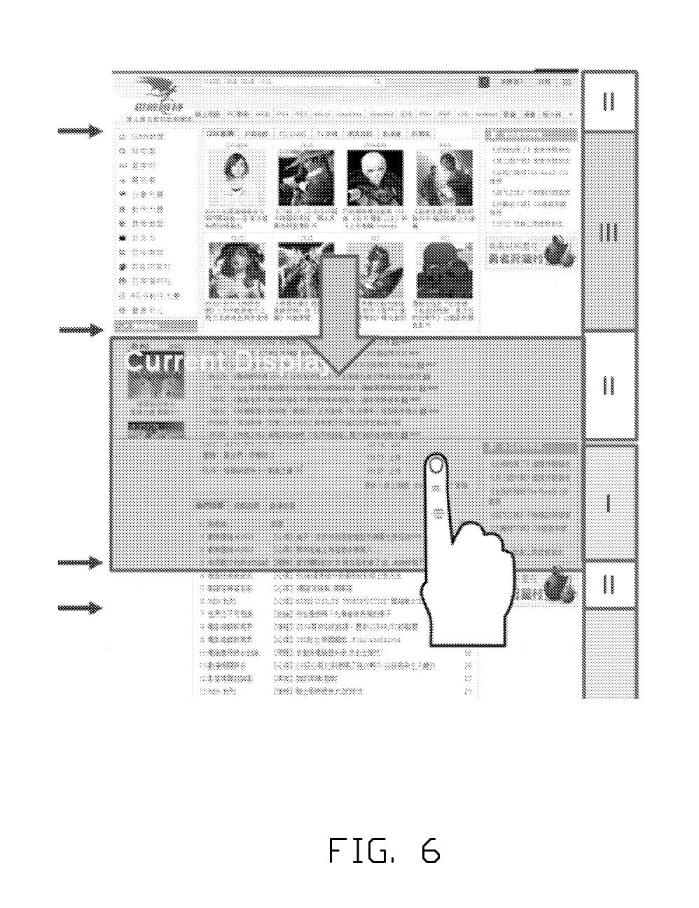

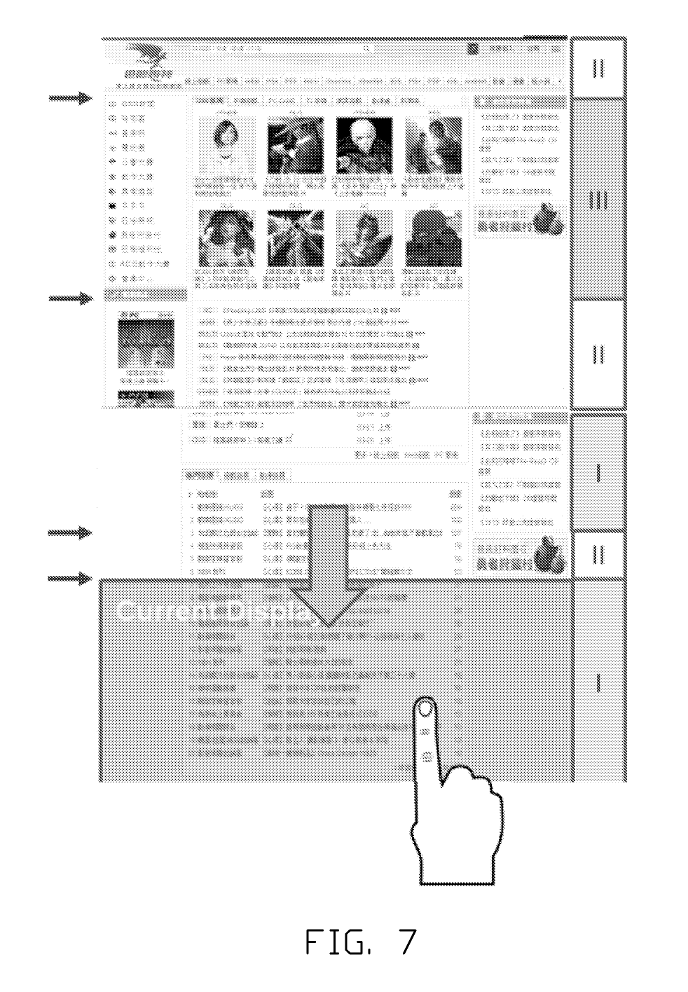

Referring to FIGS. 5-7, the webpage can be divided into the plurality of layers by the anchor setting module. The browsing determination module can receive the touch operations of the user from the sensor, and determine a browsing activity of the user. When the browsing determination module determines the layer to be browsed, the requesting module can request the resource provision module to provide the estimated amount of computing resources for browsing the corresponding layer. As illustrated in FIGS. 5-7, the webpage being browsed is divided into three levels of layers. The layer that is displayed on the display is the layer being browsed.

As illustrated in FIGS. 5-7, when both a second level layer and a third level layer are being browsed, the resource providing module can provide the estimated amount of computing resources for browsing the third level layer. When both a first level layer and the second level layer are being browsed, the resource provision module can provide the estimated amount of resources for browsing the second level layer. When only the first level layer is being browsed, the resource provision module can provide the estimated amount of resources for browsing the first level layer. Thus, an adequate amount of computing resources can always be provided when browsing the webpage.

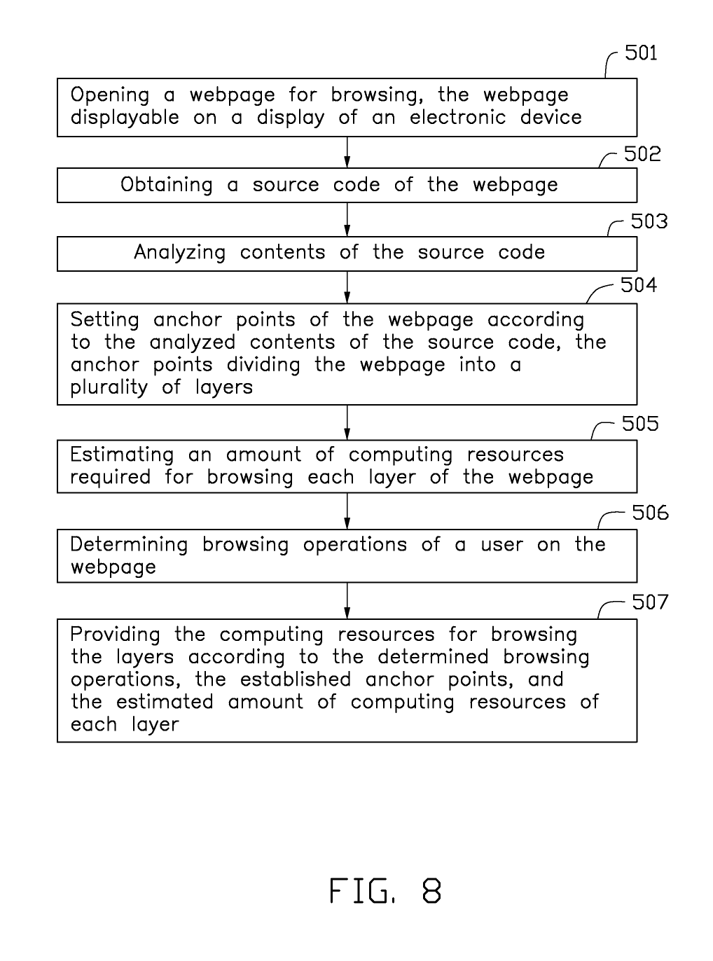

FIG. 8 illustrates a flowchart of an exemplary method for browsing data on an electronic device. The example method is provided by way of example, as there are a variety of ways to carry out the method. The method described below can be carried out using the configurations illustrated in FIGS. 1-7, for example, and various elements of these figures are referenced in explaining the example method. Each block shown in FIG. 8 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 501.

At block 501, a webpage to be browsed can be opened. The webpage can be displayed on a display of the electronic device.

At block 502, a source code of the webpage can be obtained.

At block 503, contents of the source code can be analyzed. Information of the analyzed contents can include density and distribution information of media content of the webpage.

At block 504, anchor points of the webpage can be set according to the analyzed contents of the source code. The anchor points can divide the webpage into a plurality of layers. Each layer can have a specified density range of media content, and each layer can be displayed on the display to be browsed. A higher layer can be a layer having a higher density range of media content, and a lower layer can be a layer having a lower density range of media content.

At block 505, an amount of computing resources required for browsing each layer of the webpage can be estimated.

At block 506, browsing operations of a user on the webpage can be determined.

At block 507, the computing resources can be provided for browsing the layers according to the determined browsing operations, the established anchor points, and the estimated amount of computing resources of each layer. When two or more layers are being browsed simultaneously, the computing resources for browsing the highest of the two or more layers can be provided.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for adjusting computing resources when browsing a webpage, the method comprising:
opening a webpage for browsing, the webpage displayable on a display of an electronic device;
obtaining a source code of the webpage;
analyzing contents of the source code;
setting anchor points of the webpage according to the analyzed contents of the source code, the anchor points dividing the webpage into a plurality of layers;
estimating an amount of computing resources required for browsing each layer of the plurality of layers;
determining browsing operations of a user on the webpage; and
providing the computing resources for browsing the plurality of layers according to the browsing operations, the anchor points, and the amount of computing resources required.

2. The method as in claim 1, wherein information of the analyzed contents of the source code comprises density and distribution information of media content of the webpage.

3. The method as in claim 2, wherein the media content comprises images, videos, animations, and sounds of the webpage.

4. The method as in claim 2, wherein each layer is displayable on the display and has a specified density of media content; higher layers are the layers having a higher density range of media content, and lower layers are the layers having a lower density range of media content; and the higher layers require a greater amount of computing resources for browsing.

5. The method as in claim 4, wherein when the user is browsing two or more layers simultaneously, the computing resources for browsing the highest of the two or more layers is provided.

6. An electronic device for adjusting computer resources when browsing a webpage, the electronic device comprising:
a display configured to display the webpage thereon and receive touch operations of a user;
a sensor configured to detect the touch operations on the display;
a storage device configured to store a plurality of instructions of a plurality of modules; and
a processor configured to execute the plurality of instruction of the plurality of modules, the plurality of modules comprising:
a source acquiring module configured to obtain a source code of the webpage;
a source analyzing module configured to determine a density and distribution of media content of the webpage;
an anchor setting module configured to set anchor points of the webpage to divide the webpage into a plurality of layers, each layer displayable on the display and having a specified density range of media content;
a resource provision module configured to estimate an amount of computing resources required for browsing each of the plurality of layers, and provide the estimated amount of computing resources when the layers are browsed;
a browsing determination module configured to determine the touch operations of the user when browsing the webpage; and
a requesting module configured to request the resource provision module to provide more or less computer resources according to the layers displayed on the display and the touch operations of the user.

7. The electronic device as in claim 6, wherein the media content comprises images, videos, animations, and sounds of the webpage.

8. The electronic device as in claim 6, wherein the resource provision module provides the computer resources for browsing the layers only when the browsing determination module determines that the touch operations of the user are for browsing the layers.

9. The electronic device as in claim 6, wherein the resource provision module sets aside the required amount of computer resources for browsing each layer according to the density and distribution of the media content determined by the source analyzing module, and further according to the anchors set by the anchor setting module.

10. A non-transitory storage medium having stored thereon instructions that, when executed by at least one processor of an electronic device, causes the at least one processor to execute instructions to:
open a webpage for browsing, the webpage displayable on a display of the electronic device;
obtain a source code of the webpage;
analyze contents of the source code;
establish anchor points of the webpage according to the analyzed contents of the source code, the anchor points dividing the webpage into a plurality of layers;
estimate an amount of computing resources required for browsing each layer of the webpage;
determine browsing operations of a user on the webpage; and
provide the computing resources for browsing the webpage according to the determined browsing operations, the established anchor points, and the estimated amount of computing resources of each layer.

11. The non-transitory storage medium as in claim 10, wherein information of the analyzed contents of the source code comprises density and distribution information of media content of the webpage.

12. The non-transitory storage medium as in claim 11, wherein the media content comprises images, videos, animations, and sounds of the webpage.

13. The non-transitory storage medium as in claim 11, wherein each layer is displayable on the display and has a specified density of media content; higher layers are the layers having a higher density range of media content, and lower layers are the layers having a lower density range of media content; and the higher layers require a greater amount of computing resources for browsing.

14. The non-transitory storage medium as in claim 13, wherein when the user is browsing two or more layers simultaneously, the computing resources for browsing the higher of the two or more layers is provided.
